(19) United States
(12) Patent Application Publication
(10) Pub. No.: US 2012/0291718 A1
(43) Pub. Date: Nov. 22, 2012

(54) SCRATCHING POST FOR HOUSEHOLD PETS

(76) Inventor: Cheryl Ann Williams, Malden, MA (US)

(21) Appl. No.: 13/428,999

(22) Filed: Mar. 23, 2012

Related U.S. Application Data
(60) Provisional application No. 61/466,916, filed on Mar. 23, 2011.

(51) Int. Cl. A01K 15/02

(52) U.S. Cl. 119/706

(57) ABSTRACT

This invention provides a cat scratching post with removable and/or interchangeable panels. The cat scratching post has a base, a column to house scratching panels, and a top cover. The top cover and the base are attached to the column by a nut and screw. The areas used for scratching may be exchanged as needed by simply removing the top and sliding the panel up and out and then turning it around to expose the other side. The panels may also be clipped together and attached to the column. Additional panels are stored inside the column. The panels may have different materials, colors and themes. The top cover serves a bed, which is removable for easy cleaning and is also reversible. There are also four corner pieces, which have hard plastic bumps so that the cat may rub and scratch its body. The corner pieces are also removable.

### RELATED APPLICATIONS

The present application claims the benefit of and may include subject matter related to one or more of the following commonly-owned United States patent applications, U.S. Provisional Application No. 61/466916, filed Mar. 23, 2011, which is hereby incorporated herein by reference in its entirety.

### TECHNICAL FIELD

This invention relates generally to pet care products. More specifically, the invention relates to a scratching post for household pets, particularly cats.

### BACKGROUND

It has long been assumed that when cats scratch objects with their front paws that they are sharpening their claws. It turns out that this is only a secondary reason. Research on cat behavior suggests that the major reason for this behavior is communication. By roughing up the bark of a tree, the leg of a chair, or the arm of a sofa, the cat is letting other cats or people know where they are and what they are up to.

Cats tend to pick a small number of conspicuous objects in their environments to scratch such as trees, fence posts, the corner of the couch, etc., and return to them repeatedly. This is why the tree next door looks so scratched up and why your cat may find it difficult to leave your couch alone. The scratched surface leaves a highly visible mark that can be easily seen by other cats. In addition, cats have scent glands in their paws so that when they make scratching movements, they leave odor cues that the cats can smell. The fact that cats leave scent marks by making scratching movements may be the reason that cats will continue to try to scratch objects even after they have been declawed. Declawed cats may still be leaving scent marks on objects they scratch.

We don't know exactly what cats are communicating with their scratching. Both males and females do it, it is done inside and outside the home, and even by cats living with no other cats around. It may be a territorial warning or just a marker. Cats don't scratch up furniture to be spiteful or just to be destructive, but for specific reasons, one of which is communicating. Cats also scratch to stretch, during play, and possibly as a greeting or to relieve frustration when prevented from doing other things they want to do.

It is possible to train a cat to use a scratching post; you just have to find the type of post the cat will like. Cat scratching posts may be made out of a variety of materials.

Sisal Rope: Sisal rope scratching posts and cat furniture provide long-lasting scratching surfaces for cats. Sisal is very tough and resists shredding very well. Sisal scratching posts are excellent choices for cats that prefer to claw and scratch rough surfaces, and it's useful if you want to teach your cat that carpeted surfaces are not for clawing and scratching. Sisal rope posts and furniture are also among the cheaper alternatives. The main downside to sisal is that it is not very easy to incorporate catnip into it to make it more attractive to your cat.

Carpet: Carpeted scratching posts and cat furniture make up the bulk of most manufactured scratching posts and furniture. It is easily made, easy to work with and can be attached to many different surfaces and shapes. It is also much easier to use to make larger cat trees. Carpet is not nearly as durable as sisal, so over time it shreds and loses bits of the nap, making it messy. Carpet also retains dirt and debris, so it will need occasional vacuuming.

Cardboard: Cardboard scratching surfaces are fairly new and by far the cheapest alternative. Most cardboard scratching surfaces are refillable; you buy the kit once, and then just buy the inserts that the cat scratches. Cardboard, which has a lot of holes, can easily accommodate catnip to make it more attractive; however, it shreds easily, leading to bits of cardboard around. Some cats also like to chew on cardboard, which is not good due to the chemicals present in cardboard.

Wood: Wood is another type of scratching surface. These types are not very common but are probably the closest thing to what a cat in the wild would use to stretch, mark and shed on. A wood post will be very durable, more so than sisal. It does not lend itself to hosting catnip, but it also will not retain dirt or leave bits of itself lying around.

Horizontal or Vertical: One other thing to consider when buying a cat scratching post or furniture is whether or not the cat prefers vertical or horizontal surfaces. Some cats like to rear up and pull down, while others like to stretch way out along the floor and pull. Most large cat trees provide both surfaces, while the basic post is more for vertical than horizontal. Cardboard scratchers tend to lie directly on the floor. Some types of vertical scratching posts can be hung from a doorknob or off the back of a door. The best thing you can do is observe the cat. If the cat tends to rear up to claw, then a vertical post is a good choice. If the cat favors carpet or rugs, then a floor-based horizontal kit is better.

### SUMMARY

This invention overcomes the disadvantages of the prior art by providing a cat scratching post with removable and/or interchangeable panels. In one embodiment, the cat scratching post has a base, a column to house the scratching panels, and a top cover. The top cover and the base connect to the column via a nut and screw. The top cover serves a bed or perch, which is removable for easy cleaning and is also reversible. There are also four corner pieces, which have hard plastic bumps or nubs, so that the cat may rub and scratch areas of its own body. The corner pieces are also removable. The areas used for scratching may be exchanged as needed by simply removing the top and sliding the panel up and out and then turning it around to expose the other side. In an alternative embodiment, the panels may clip together to form the column. Thus, soiled or scratched up panels may be inverted quickly. Additional panels are stored inside the column. Other items, such as cleaning products, dusting implements and liquid catnip may also be stored in the column. The panels may have different materials, colors and themes to match the decor in the owner's home or the season. All areas of the unit may be easily sanitized and/or disinfected at any time. Thus, unlike the cat scratching posts currently available, the unit is more economical because it only needs to be purchased once and the inserts are purchased as needed. The unit comes in three sections, not including the inserts, for easy shipping, assembly, and transportation.

Thus, the present invention solves the problems of the cat scratching posts currently available by eliminating unsightly areas overused and/or scratched by the cat. Since the entire unit is not all carpeted like those currently sold, it is more sanitary for the household because any area of the unit may be individually cleaned and/or disinfected to avoid odors.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

The invention description below refers to the accompanying drawings, of which:

FIG. 1 is a diagrammatical front view of the scratching post of the present invention.

FIG. 2 is a side view of one embodiment the scratching post of the present invention.

FIG. 3 is a side view of the scratching post of the present invention illustrating an alternate top cover material and alternate insert.

FIG. 4 is a perspective view of an alternative embodiment of the scratching post of the present invention.

FIG. 5 is a perspective view of the scratching post of the present invention with the top cover removed to show the interior storage space of the column.

FIG. 6 is a perspective view of the scratching post of the present invention illustrating the removable insert.

FIG. 7 is a diagrammatical top view of the scratching post of the present invention

FIG. 8 is a top view of the scratching post of the present invention.

FIG. 9 is a top perspective view of the scratching post of the present invention.

FIG. 10 is a diagrammatical top view of an alternative embodiment of the present invention.

FIG. 11 is a perspective view of one of the screws attaching the base to the column.

FIG. 12 is a close up view of the nut that secures the screw illustrated in FIG. 11.

### DETAILED DESCRIPTION

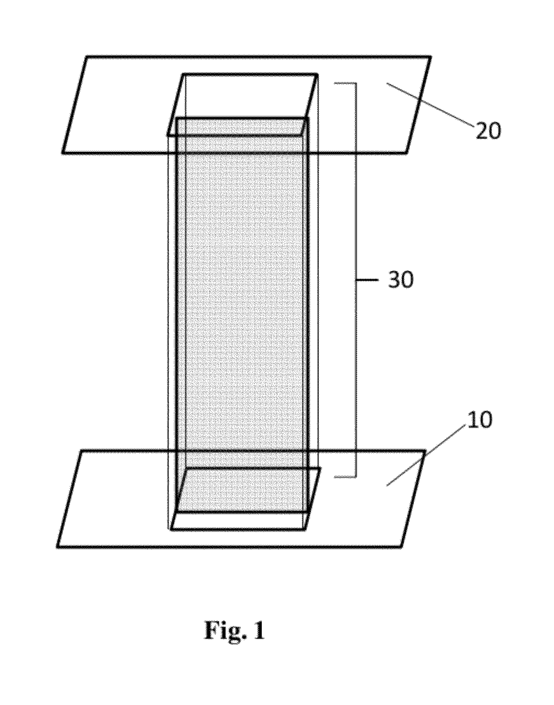

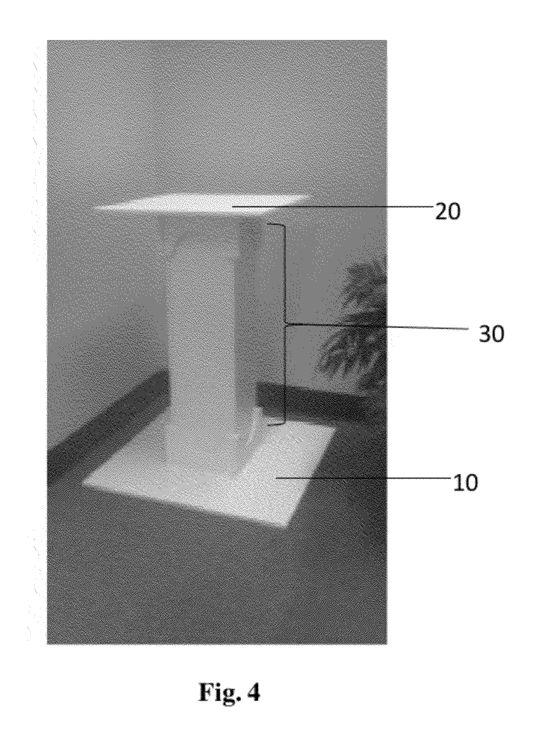

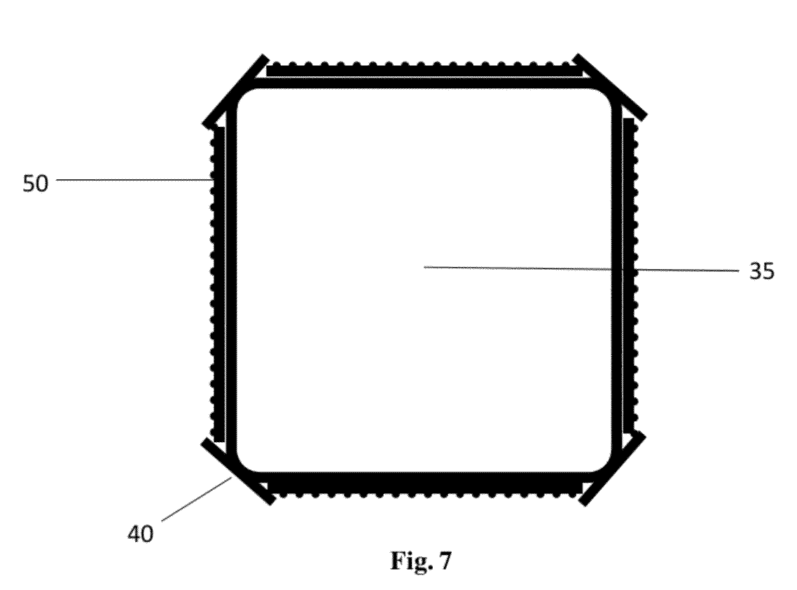

Referring to the drawings in general and to FIGS. 1-12 in particular, there is provided a scratching post 100 for household pets in accordance with the present invention.

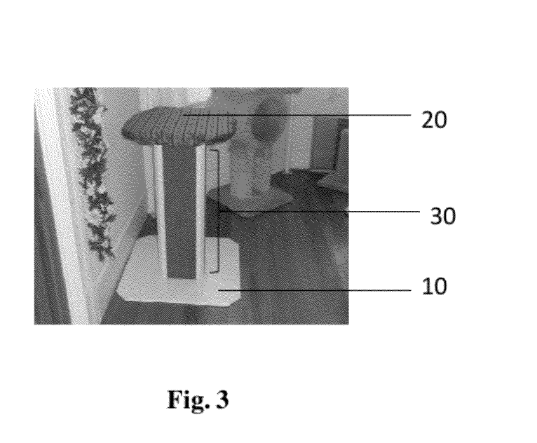

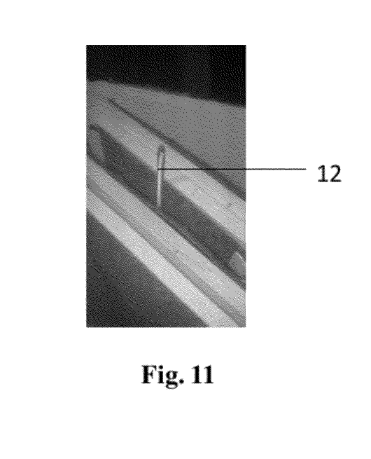

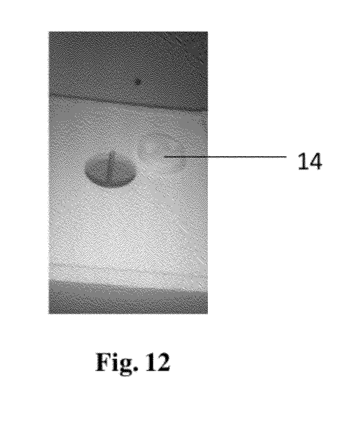

Referring to FIG. 1, one embodiment of the scratching post 100 of the present invention includes a base 10, a top cover 20, and a column 30 that extends vertically from base 10 to top cover 20. In an alternative embodiment, shown in FIG. 3, base 10 and top cover 20 each have a decorative extension in between which column 30 is positioned. Top cover 20 and base 10 are attached to column 30 by a screw 12 and nut 14 (see FIGS. 11 and 12).

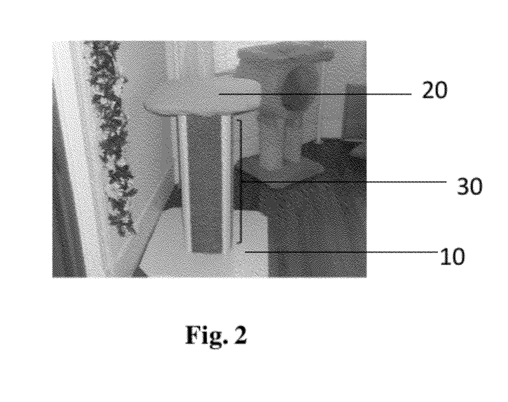

Base 10 should be large enough to provide sufficient stability to scratching post 100 such that it remains upright while the cat is scratching the scratching post or when the cat is sitting upon top cover 20. In one embodiment, base 10 is approximately 24 inches wide by approximately 24 inches long. In one embodiment, base 10 is made from wood, but may be made of other materials, such as particle board, press board, plastic, metal, glass, stone, or any other decorative material. In one embodiment, base 10 is substantially square in shape, but may have other geometric shapes, such as circular, triangular, or polygonal. As shown in FIGS. 2 and 3, the corners of base 10 may be angled to minimize or even prevent possible injury to a cat and/or an owner when coming into contact therewith. Base 10 is removable for ease in assembly and cleaning of the cat scratching post.

Column 30 is formed from pieces of wood joined together to form a rectangular structure that has a hollow interior. In one embodiment, column 30 is approximately 24 inches in height by approximately 7.5 inches in width. In another embodiment, column 30 is approximately 30 inches in height by approximately 8 inches in width. Additionally, the pieces of wood used to form column 30 are approximately ⅞ inches in thickness. In other embodiments, column 30 may be made of other materials, such as particle board, press board, plastic, metal, glass, stone, or any other decorative material. In one embodiment, column 30 is substantially square in shape, but may have other geometric shapes, such as circular, triangular, or polygonal.

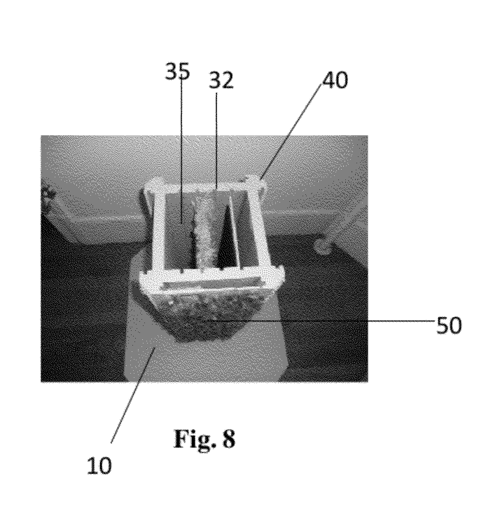

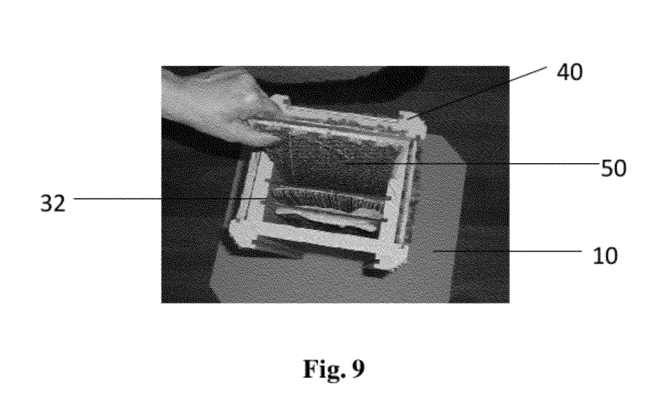

As illustrated in FIGS. 8 and 9, the hollow interior 35 of column 30 may be used for storage. In one embodiment, hollow interior 35 measures approximately 7.5 inches by 7.5 inches.

The interior side of each piece of wood forming column 30 has a series of grooves. The grooves 32 on one piece of wood correspond with the grooves on an opposing piece of wood to form a series of slots. In one embodiment, the slots are positioned approximately 1.5 inches apart.

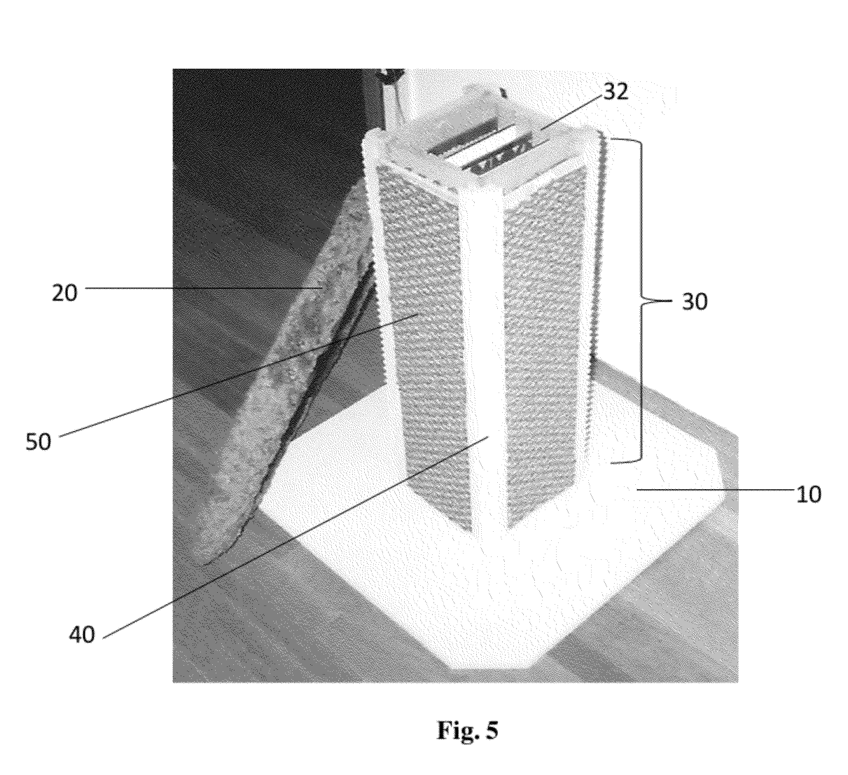

Referring to FIG. 5, corner pieces 40 are attached to each corner edge of column 30. Corner pieces 40 have a frusto-pyramidal shape. The interior of corner piece 40 has a strip containing a groove. This groove snaps onto the corner edge of column 30. Thus, corner pieces 40 are removable. The top surface of each corner piece 40 has a series of bumps or nubs 45 that the cat may use to scratch and rub itself. In one embodiment, corner pieces 40 are made of plastic, but may be made of other materials, such as rubber. The sides of corner pieces 40 extend outward and are spaced away from the walls of column 30.

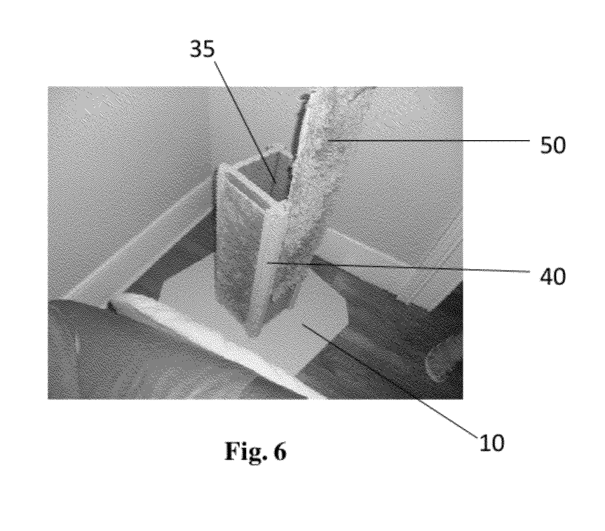

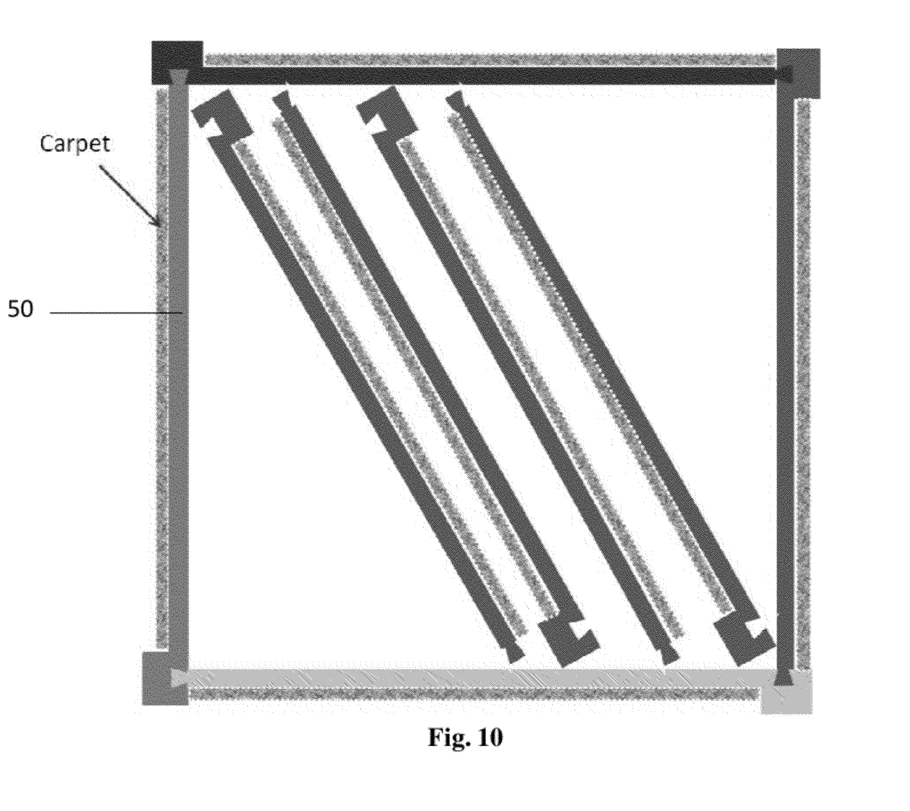

An insert 50 having a material that a cat can scratch is positioned in the space between the sides of corner pieces 40 and the walls of column 30. As shown in FIG. 6, insert 50 slides up and down in the slots formed between the sides of corner pieces 40 and the wall of column 30. Alternatively, inserts 50 may also clip together using a tongue and groove mechanism to form column 30 (see FIG. 10). In one embodiment, insert 50 is made of wood. In other embodiments, insert 50 may be made of other materials, such as particle board, press board, plastic, metal, glass, stone, or any other decorative material. In one embodiment, insert 50 is approximately 6.5 inches wide and approximately 23 inches in height. In another embodiment, insert 50 is approximately 6 inches wide and approximately 29 inches in height.

Insert 50 is removable and reversible. Thus, when one side of insert 50 become damaged or soiled, it may be removed and reversed to use the other side. When both sides have been used, insert 50 may be replaced with a new one. As illustrated in FIGS. 8 and 9, each insert 50 is stored in hollow interior 35 of column 30. Each insert 50 fit into the slots on the interior walls of column 30.

The cat scratching material is an outer covering that a cat claws during use. In one embodiment, the covering is one uniform piece of material. In other embodiments, a number of pieces or sections of cat scratching material having different patterns, colors, or textures may be used. In one embodiment, the cat scratching material is a carpet material. In other embodiments, the cat scratching material may be fabric, rope, or any other suitable material. In one embodiment, the cat scratching material is affixed to the outer and inner surfaces of the insert by an adhesive. Alternatively, the cat scratching material may be affixed to the outer surface and inner surface of the insert by tape, staples, and/or hook and loop fasteners.

Top cover 20 is designed to be large enough to be used as a bed or perch for the cat. In one embodiment, top cover 20 is approximately 18 inches wide by approximately 18 inches long. In one embodiment, top cover 20 is made from wood, but may be made of other materials, such as particle board, press board, plastic, metal, glass, stone, or any other decorative material. In one embodiment, top cover 20 is substantially rectangular in shape, but may have other geometric shapes, such as circular, triangular, or polygonal. The corners of top cover 20 may be angled to minimize or even prevent possible injury to a cat and/or an owner when coming into contact therewith. As shown in FIG. 5, top cover 20 is removable for ease in assembly and cleaning of the cat scratching post and protects the inserts housed in the column. In one embodiment, top cover 20 is encased in a carpet material. However, other materials, such as fabric, may be used. Alternatively, a layer of padding, such as cotton batting or foam, may be positioned between the carpet material and top cover 20.

The foregoing has been a detailed description of illustrative embodiments of the invention. Various modifications and additions can be made without departing from the spirit and scope if this invention. Each of the various embodiments described above may be combined with other described embodiments in order to provide multiple features. Furthermore, while the foregoing describes a number of separate embodiments of the apparatus and method of the present invention, what has been described herein is merely illustrative of the application of the principles of the present invention. Accordingly, this description is meant to be taken only by way of example, and not to otherwise limit the scope of this invention.

1. A scratching post for household pets comprising:
a base;
a top cover; and
a column extending vertically from the base, the column having a first end and a second end, and wherein the base is adapted to be removably attached to the first end of the column and the top cover is adapted to be removably attached to the second end of the column.

2. The scratching post for household pets of claim 1 wherein the base, the column, and the top cover are made of a material selected from the group consisting of wood, stone, glass, metal, ceramic, plastic, fabric, and a combination thereof.

3. The scratching post for household pets of claim 1 wherein the base, the top cover, and the column are a geometric shape selected from the group consisting of circle, oval, trapezoid, square, rectangular, triangle, and polygonal.

4. The scratching post for household pets of claim 1 wherein the top cover is encased in a material selected from the group consisting of carpet, fabric, and a combination thereof.

5. The scratching post for household pets of claim 4 wherein the top cover further comprises a layer of padding positioned between the material and the top cover.

6. The scratching post for household pets of claim 5 wherein the layer of padding is made of a material selected from the group consisting of cotton batting, foam, and a combination thereof.

7. The scratching post for household pets of claim 1 wherein the column has a hollow interior.

8. The scratching post for household pets of claim 1 wherein the column comprises a plurality of walls, each wall having an outer surface and an inner surface, wherein the inner surface of each wall further comprises a plurality of grooves.

9. The scratching post for household pets of claim 1 further comprising a plurality of corner pieces.

10. The scratching post for household pets of claim 9 wherein the plurality of corner pieces are frusto-pyramidal in shape.

11. The scratching post for household pets of claim 9 wherein an interior portion of each of the corner pieces comprises a centrally positioned strip containing a groove.

12. The scratching post for household pets of claim 9 wherein each of the corner pieces is adapted to be removably attached to a side edge of the column.

13. The scratching post for household pets of claim 9 wherein a top surface of each of the corner pieces comprises a plurality of nubs.

14. The scratching post for household pets of claim 9 wherein each of the corner pieces comprises a side portion, the side portion extending outward and spaced away from the column.

15. The scratching post for household pets of claim 9 wherein the plurality of corner pieces is made of a material selected from the group consisting of plastic, rubber, and a combination thereof.

16. The scratching post for household pets of claim 1 further comprising a plurality of inserts.

17. The scratching post for household pets of claim 16 wherein the inserts are made of a material selected from a group consisting of wood, stone, glass, metal, ceramic, plastic, fabric, and a combination thereof.

18. The scratching post for household pets of claim 16 wherein the inserts are adapted to slidably engage the corner pieces.

19. The scratching post for household pets of claim 16 wherein the inserts are adapted to clip together and attach to the column.

20. The scratching post for household pets of claim 16 wherein the inserts are removable and reversible.

21. The scratching post for household pets of claim 16 wherein the inserts are stored in the hollow interior of the column.

22. The scratching post for household pets of claim 16 wherein an outer surface and an inner surface of each insert is covered with a scratchable material.

23. The scratching post for household pets of claim 22 wherein the scratchable material is selected from the group consisting of carpet, fabric, rope, and a combination thereof

24. The scratching post for household pets of claim 22 wherein the scratchable material is affixed to the outer surface and the inner surface of the insert by a means selected from the group consisting of adhesive, tape, staples, hook and loop fasteners, and a combination thereof.

25. A scratching post for household pets comprising:
a base;
a top cover;
a column extending vertically from the base, the column having a first end and a second end, and wherein the base is adapted to be removably attached to the first end of the column and the top cover is adapted to be removably attached to the second end of the column;
a plurality of corner pieces, each corner being adapted to removably attached to a side edge of the column; and
a plurality of inserts, the inserts being adapted to slidably engage the corner pieces.
